(19) United States
(12) Patent Application Publication
(10) Pub. No.: US 2021/0087823 A1
(43) Pub. Date: Mar. 25, 2021

(54) Self-Supporting Hand Guardrail

(71) Applicant: The Boeing Company, Chicago, IL (US)

(72) Inventor: Stanley W. Stawski, Chicago, IL (US)

(21) Appl. No.: 16/578,700

(22) Filed: Sep. 23, 2019

(51) Int. Cl. E04F 11/18

(52) U.S. Cl. CPC E04F 11/1865; E04F 2011/1876

(57) ABSTRACT

The present disclosure relates to various apparatuses and folding apparatuses configured to support weight of a user. An example apparatus includes a base frame and a base plate coupled to the base frame. The base plate is configured to support the weight of the user. The apparatus also includes a plurality of posts coupled to the base frame. Each post includes a lower portion, a middle portion, and an upper portion. The plurality of posts includes at least a first post and a second post. The apparatus also includes a plurality of support gussets. Each support gusset is coupled to the base frame and a respective upper portion of at least one post. The apparatus additionally includes a rail coupled between respective upper portions of at least the first post and the second post. The apparatus resists tipping based in part on the weight of the user.

### FIELD

The present disclosure generally relates to systems and methods involving adjustable walkway platforms and/or movable guardrails.

### BACKGROUND

During their manufacture in an airplane production facility, aircraft move along the production line between different stages of assembly. This periodic (e.g., daily) movement is called “pulsing” the production line.

In some stages of assembly, personnel may access elevated portions of the aircraft by way of fixed deck platforms positioned within a few feet from the respective sides of the aircraft's fuselage. In such scenarios, movable deck platforms (e.g., flip doors) may be coupled to the fixed deck platforms and may be operable to provide personnel with the remaining platform access up to the body of the aircraft.

Prior to pulsing the production line, the movable deck platforms may be manually rotated (e.g., raised upward or lowered downward away from the fuselage) so as to provide sufficient clearance for airplane movement along the production line. To avoid falls from the fixed deck platform at this stage, removable guardrails can be manually installed near the end of the fixed deck platform.

Once a new airplane is in a proper position along the production line, the guardrails may be manually removed and the movable deck platform could be reinstalled or rotated to a horizontal position to once again close the gap between the fixed deck platform and the aircraft fuselage and provide standing access for personnel immediately next to the fuselage.

Frequent handling of the removable guardrail sections, which can weigh 40 pounds or more, can lead to repetitive lift injuries. Furthermore, personnel who install and remove the guardrails can be at particular risk of falling or dropping the guardrails.

### SUMMARY

In an aspect, an apparatus is described. The apparatus includes a base frame and a base plate coupled to the base frame. The base plate is configured to support weight of a user. The apparatus also includes a plurality of posts coupled to the base frame, each post having a lower portion, a middle portion, and an upper portion. The plurality of posts includes at least a first post and a second post. The apparatus also includes a plurality of support gussets. Each support gusset is coupled to the base frame and a respective upper portion of at least one post. The apparatus additionally includes a rail coupled between respective upper portions of at least the first post and the second post. The apparatus resists tipping based in part on the weight of the user.

In another aspect, a foldable apparatus is described. The foldable apparatus includes a base frame and a base plate coupled to the base frame. The base plate is configured to support weight of a user. The foldable apparatus includes a plurality of posts rotatably coupled to the base frame, each post having a lower portion, a middle portion, and an upper portion. The plurality of posts includes at least a first post and a second post. The foldable apparatus also includes a plurality of support gussets. Each support gusset is rotatably coupled to the base frame and a respective upper portion of at least one post. The foldable apparatus also includes rail coupled between respective upper portions of at least the first post and the second post. The foldable apparatus resists tipping based in part on the weight of the user. The support gussets are configured to rotatably fold so as to adjust the plurality of posts and the base frame between a deployed configuration and a folded configuration.

Other aspects, examples, and implementations will become apparent to those of ordinary skill in the art by reading the following detailed description with reference, where appropriate, to the accompanying drawings.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying drawings, wherein:

FIG. 1 illustrates an apparatus, according to an example implementation.

FIG. 2A illustrates an apparatus, according to an example implementation.

FIG. 2B illustrates an apparatus, according to an example implementation.

FIG. 3A illustrates an apparatus, according to an example implementation.

FIG. 3B illustrates an apparatus, according to an example implementation.

FIG. 3C illustrates an apparatus, according to an example implementation.

FIG. 4A illustrates a scenario, according to an example implementation.

FIG. 4B illustrates a scenario, according to an example implementation.

FIG. 5 illustrates a foldable apparatus, according to an example implementation.

FIG. 6 illustrates various configurations of a foldable apparatus, according to an example implementation.

### DETAILED DESCRIPTION

### I. Overview

Example methods, devices, and systems are described herein. It should be understood that the words “example” and “exemplary” are used herein to mean “serving as an example, instance, or illustration.” Any example or feature described herein as being an “example” or “exemplary” is not necessarily to be construed as preferred or advantageous over other examples or features. Other examples can be utilized, and other changes can be made, without departing from the scope of the subject matter presented herein.

Thus, the examples described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall examples, with the understanding that not all illustrated features are necessary for each example.

The present disclosure describes an apparatus to prevent a user from falling off of a step or a raised platform. In some embodiments, the apparatus could be formed from a lightweight material (e.g., aluminum, plastic, and/or wood) so that the apparatus is portable. The apparatus could include a base for the user to stand on and to prevent the apparatus from tipping. The base could include a cushioned pad to provide ergonomic support. The cushioned pad could be formed from foam or another soft material. The apparatus additionally includes a hand rail to provide support to the user. The apparatus may include a plurality of side gussets to prevent the user from stepping off of a side of the apparatus.

In example embodiments, the apparatus could be a portable guard rail that is self-weighted so that when a user stands on the base, the apparatus is prevented from tipping over. Such an apparatus may protect workers from fall injuries while providing the flexibility and mobility of an easily portable guardrail. The self-weighted, portable guardrail may help prevent workers from falling or stepping off of a platform during manufacturing operations. Such a device may improve safety and/or ergonomics of manufacturing operations.

In some embodiments, the guardrail system described herein could be intended to comply with various federal and state safety guidelines, such as, but not limited to, current Occupational Safety and Health Administration (OSHA) Regulation 1910.29 (Fall protection systems) (See e.g., Federal Register Volume 81, Issue 223, Nov. 18, 2016). Other United States and international safety standards could be addressed by way of the present apparatus as well.

### II. Example Apparatus

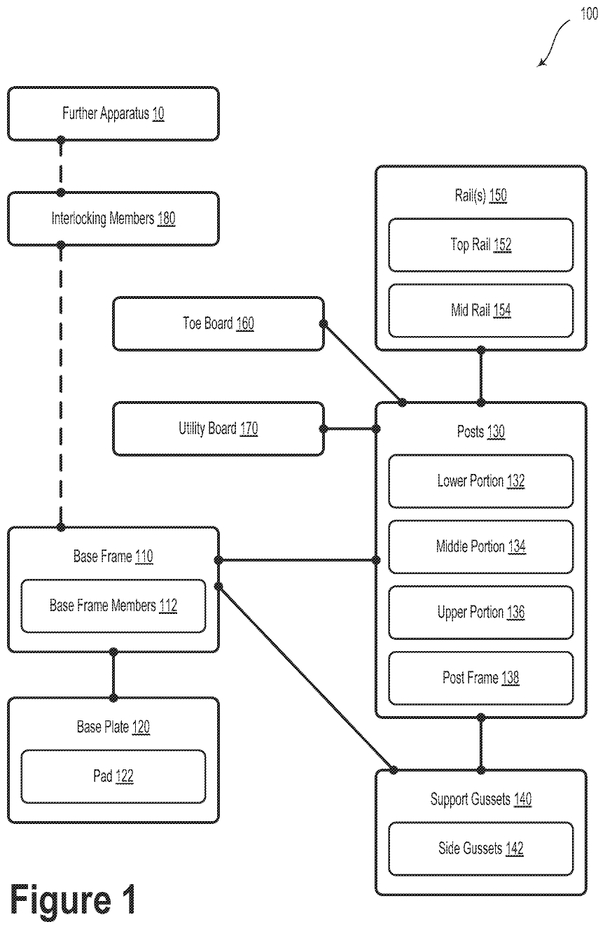

FIG. 1 illustrates an apparatus 100, according to an example implementation. The apparatus 100 includes a base frame 110. The apparatus 100 also includes a base plate 120 coupled to the base frame 110. The base plate is configured to support weight of a user (e.g., a worker). In some embodiments, the base plate 120 could be formed from a ¼″-thick plastic sheet affixed to the base frame 110. However, other materials and/or thicknesses are possible and contemplated.

In some embodiments, apparatus 100 could be configured to provide a personal work platform or work stand. In such a scenario, the base frame 110 and base plate 120 could be configured to support at least one user. As an example, the base frame 110 and the base plate 120 could be configured to support at least 350 pounds or more. The base plate 120 could be textured and/or marked so as to indicate where a user may stand. As an example, the base plate 120 could have a set of marked “foot prints” that may indicate a standing location for a user.

In various embodiments, an underside surface of the base frame 110 and/or base plate 120 could include a non-marking and/or non-slip surface. As an example, the non-marking and/or non-slip surface may include a textured rubber material.

The apparatus 100 additionally includes a plurality of posts 130 coupled to the base frame 110. In such scenarios, each post 130 includes a lower portion 132, a middle portion 134, and an upper portion 136. In some embodiments, the plurality of posts 130 includes at least a first post 130a and a second post 130b. In some embodiments, the first post 130a and the second post 130b may be set back from an edge of the base frame 110 by approximately 4-12 inches. In some embodiments, the base frame 110 could be approximately 2-3 feet wide. However, other widths of the base frame 110 are possible and contemplated.

The apparatus 100 also includes a plurality of support gussets 140. Each support gusset 140 is coupled to the base frame 110 and a respective upper portion 136 of at least one post 130. The support gussets 140 could be diagonal braces that physically support the plurality of posts 130.

The apparatus 100 additionally includes a rail 150 coupled between respective upper portions 136 of at least the first post 130a and the second post 130b. The apparatus 100 resists tipping based in part on the weight of the user on the base plate 120. In some embodiments, the apparatus 100 could be designed in part based on the center of gravity (CG) of a user, who may stand and/or work on the apparatus 100. For example, the position and/or dimension of various elements of the apparatus 100 could be configured so as to avoid tipping over while a user is performing work operations while standing on the apparatus 100.

The various elements of apparatus 100 could be formed from round and/or square metal tubing, rods, pins, or bars. Some elements of apparatus 100 could be formed from L- or C-shaped metal (e.g., angle or channel structural materials). Additionally or alternatively, the various elements of apparatus 100 could be formed from one or materials such as aluminum, steel, wood, plastic, and/or another material. Furthermore, it will be understood that such parts could additionally or alternatively be formed from machined parts.

In some embodiments, the apparatus 100 includes a mid rail 154 coupled between respective middle portions 134 of at least the first post 130a and the second post 130b. In such scenarios, the apparatus 100 could include a toe board 160. The toe board 160 could include a flat material arranged along a plane between the first post 130a and the second post 130b and between the mid rail 154 and base frame 110. The toe board 160 could be plastic or another rigid material. In various embodiments, the toe board 160 may help prevent a user from leaning too far forward. As such, the toe board 160 may provide greater stability for the user. For example, the toe board 160 may help prevent the CG of the user from moving too far forward with respect to the apparatus 100.

In some embodiments, the apparatus 100 could additionally include a pad 122. In such scenarios, the pad 122 is coupled to the base plate 120. In some embodiments, the pad 122 includes a cushioning material. In various examples, the cushioning material could include foam and/or rubber. In some examples, the pad 122 could include a tacky, sticky, or grippy material.

In various embodiments, the plurality of support gussets 140 includes at least two side gussets 142. The at least two side gussets 142 are arranged proximate to opposing sides of the base frame 110. The side gussets 142 are configured to prevent the user from stepping off the sides of the apparatus 100. For example, the side gussets 142 may physically block the user from moving laterally when standing on the apparatus 100.

In example embodiments, the apparatus 100 could include a lightweight material. For example, the lightweight material could include at least one of: molded plastic, polyvinylchloride pipe, aluminum round or square tube, carbon fiber, steel, wood, bamboo, or wicker. In such scenarios, the apparatus 100 could weigh less than ten pounds.

In various embodiments, the apparatus 100 could also include interlocking members 180 coupled to the base frame 110 and/or other portions of the apparatus 100. The interlocking members 180 could be configured to interlock with a further base frame of a further apparatus 10 such that the apparatus 100 and the further apparatus 10 are configured to be fixedly coupled to each another.

In some embodiments, the apparatus 100 could include a post frame 138. The post frame includes at least two of the posts (e.g., 130a and 130b) and the rail 150. In such scenarios, the apparatus could include a utility board 170 coupled to the post frame 138. For example, the utility board 170 includes at least one tool storage pocket. In such a scenario, the tool storage pocket could include locations to store tools, parts, and/or fasteners, among other examples. For instance, the tool storage pocket could be configured to provide a user with convenient access to various hand tools, power tools, diagnostic equipment, safety equipment (e.g., gloves, eyewear, helmet, and/or consumables such as nails, screws, rivets, or other types of fasteners. In an example embodiment, the utility board 170 could include a reconfigurable peg board. It will be understood that other ways to provide a user with access to tools and/or working materials are possible and contemplated.

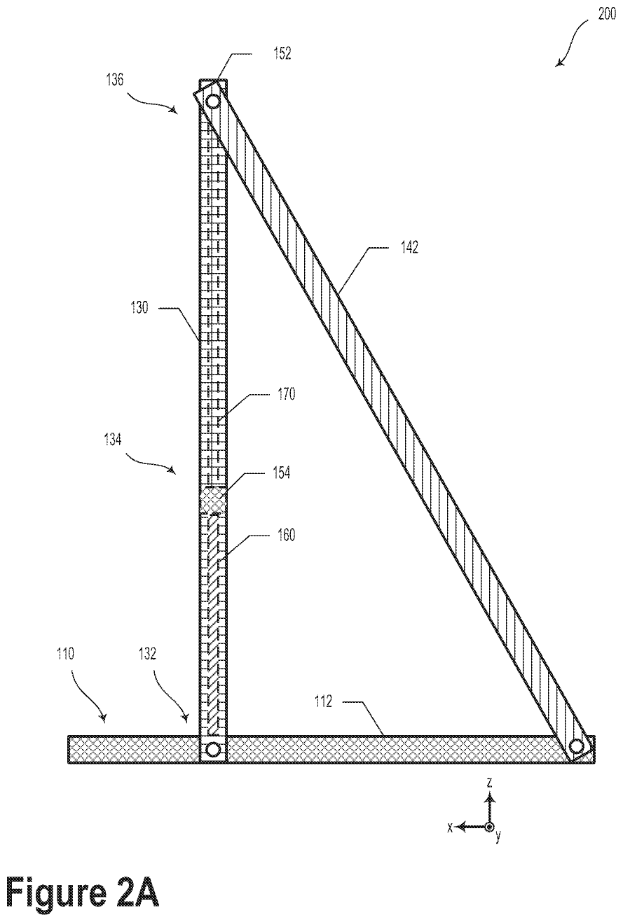

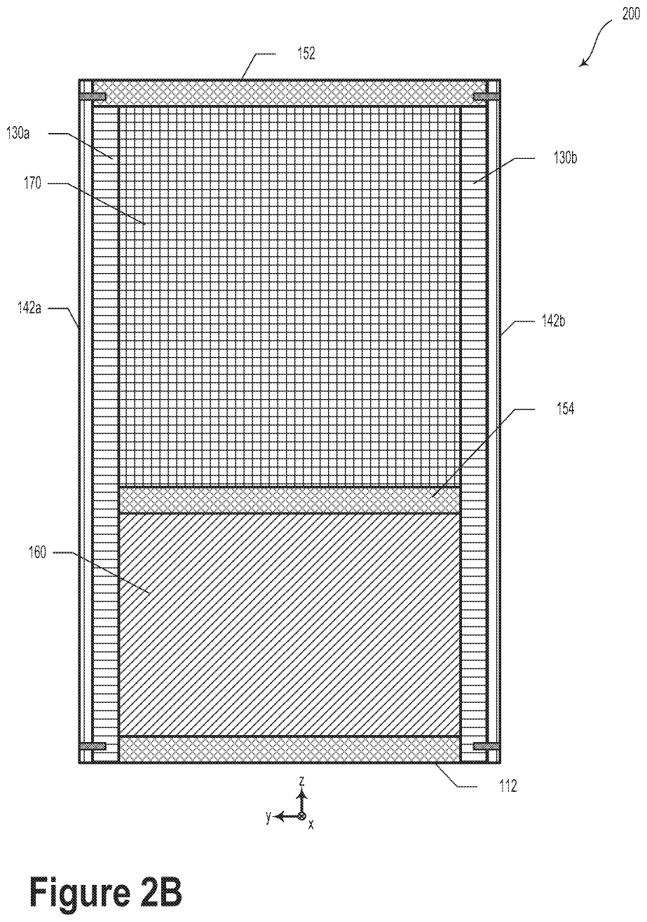

FIGS. 2A and 2B illustrate various views of an apparatus 200, according to an example implementation. The apparatus 200 could be similar or identical to apparatus 100, as illustrated and described in reference to FIG. 1. For example, a plurality of posts 130 (e.g., post 130a and post 130b) could be coupled to base frame members 112 of a base frame 110. The apparatus 200 also includes a plurality of support gussets 142a and 142b, which are coupled to a top rail 152 and at least one base frame member 112.

In various embodiments, the apparatus 200 could include a mid rail 154, which may be coupled between respective middle portions 134 of posts 130a and 130b. Additionally or alternatively, the apparatus 200 could include a toe board 160 and/or a utility board 170.

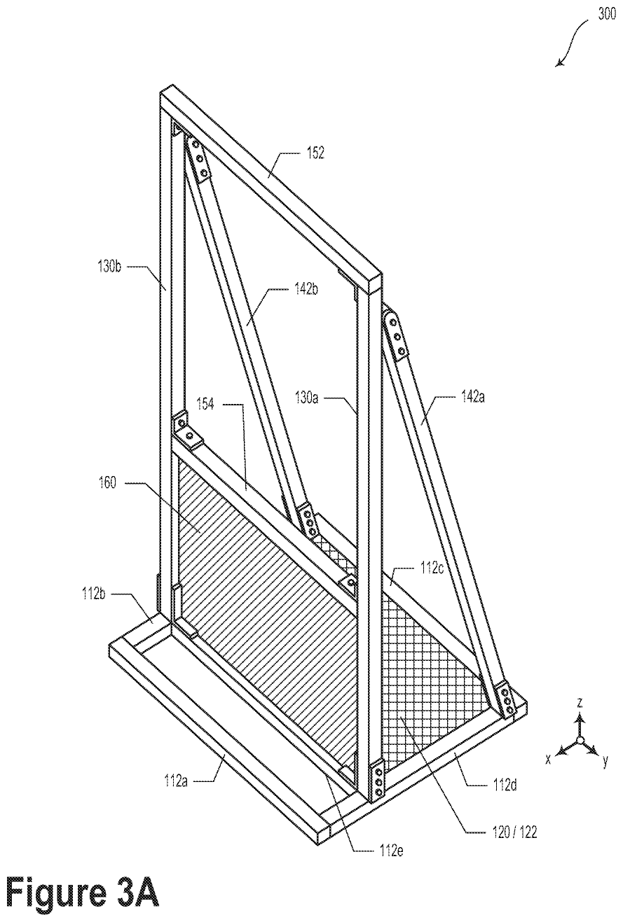

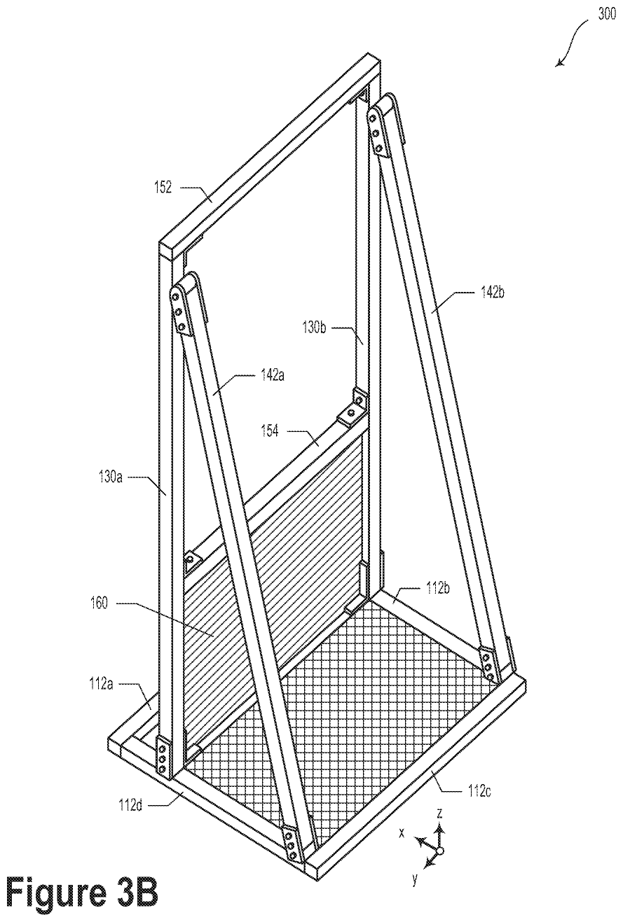

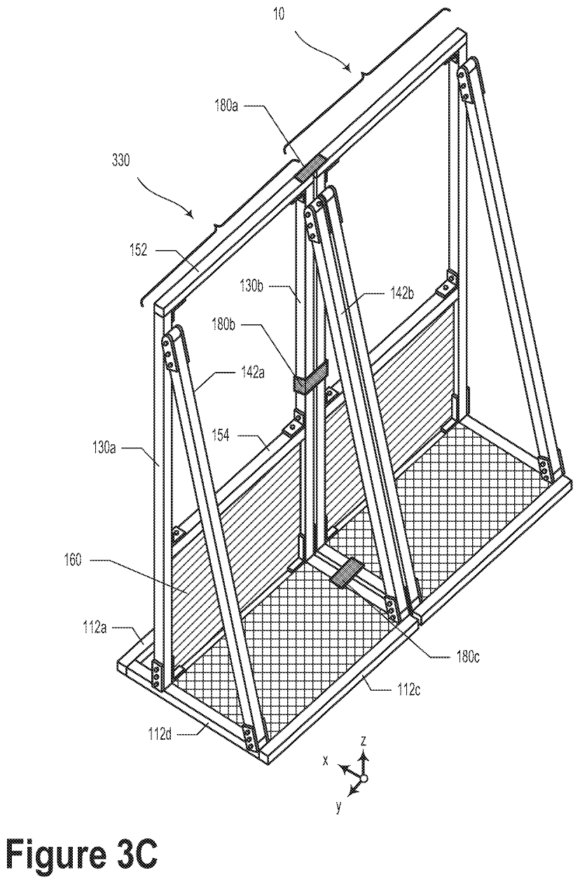

FIGS. 3A and 3B illustrate an apparatus 300, according to an example implementation. Apparatus 300 could be similar or identical to apparatus 100 and/or apparatus 200, as illustrated and described in reference to FIGS. 1, 2A, and 2B. As illustrated in FIGS. 3A and 3B, the base frame 110 could include a combination of base frame members 112a, 112b, 112c, and 112d. In some embodiments, the base frame 110 could also include base frame member 112e, which may serve as a cross-brace for the post frame 138. The post frame 138 could include respective posts 130a and 130b, top rail 152, and mid rail 154.

FIG. 3C illustrates an apparatus 330 and a further apparatus 10. In some embodiments, apparatus 330 could be similar or identical to apparatus 100, 200, and/or 300, as illustrated in FIGS. 1, 2A, 2B, 3A and 3B. In embodiments, the apparatus 330 could be fixedly coupled to the further apparatus 10 by way of one or more interlocking members 180 (e.g., interlocking members 180a, 180b, and 180c). The interlocking members 180 could include a coupling bracket, a C- or L-shaped plate, a rotatable bar and retaining latch, or a flexible tie (e.g., a zip tie or a rope tie), among other possibilities. While FIG. 3C illustrates interlocking members 180a, 180b, and 180c being disposed at particular locations, it will be understood that other locations are possible and contemplated. Furthermore, while FIG. 3C illustrates three interlocking members, it will be understood that more or fewer interlocking members are possible and contemplated.

In some embodiments, a plurality of apparatuses 330 (e.g., two, three, four, five or more apparatuses) could be coupled together along an edge of a raised platform.

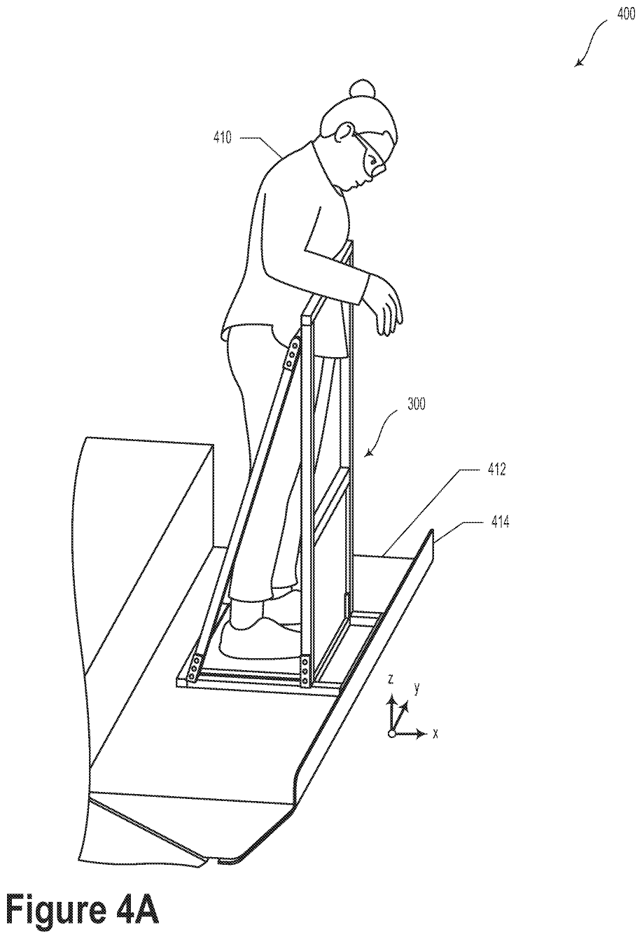

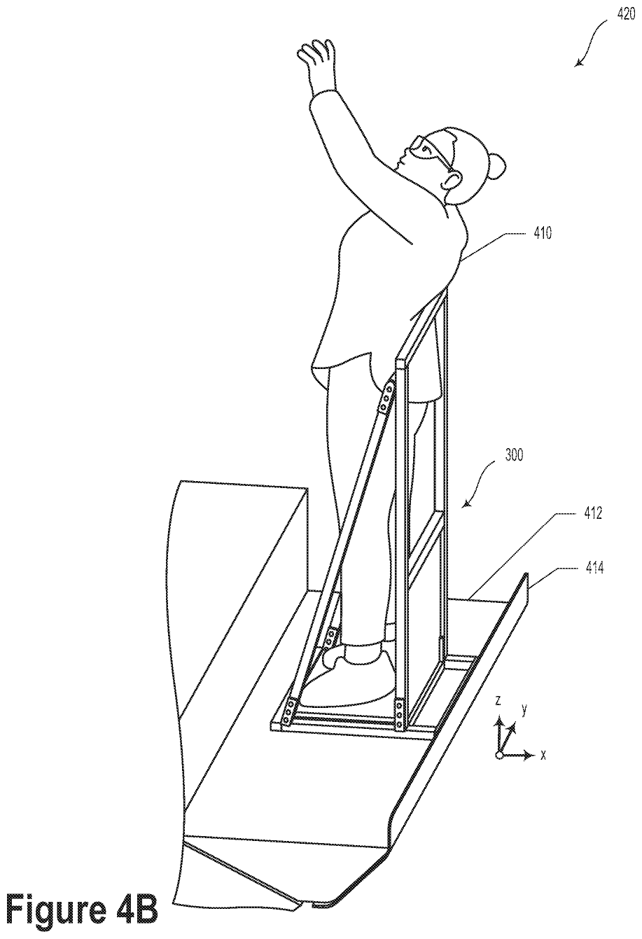

FIG. 4A illustrates a scenario 400, according to an example implementation. Scenario 400 may include a user 410 standing on apparatus 300. Apparatus 300 could be arranged along a raised platform 412 and abutted against a platform edge 414. In such a scenario, the user 410 may be able to perform service or work on a structure located beyond the platform edge 414. That is, the user 410 may be able to reach in the +x direction while being supported by the apparatus 300 and with reduced risk of falling off of the raised platform 412.

FIG. 4B illustrates a scenario 420, according to an example implementation. Similar to scenario 400, scenario 420 could include a user 410 standing on apparatus 300. The apparatus 300 could be arranged along a raised platform 412 and abutted against a platform edge 414. In scenario 420, the user 410 could additionally or alternatively be able to reach upward (e.g., in the +z direction) and/or rearward (e.g., in the −x direction) while being supported by the apparatus 300. As illustrated in FIGS. 4A and 4B, the apparatus 300 may provide improved safety for user 410 by providing physical support and/or stabilization to avoid injury and falls.

### III. Example Foldable Apparatus

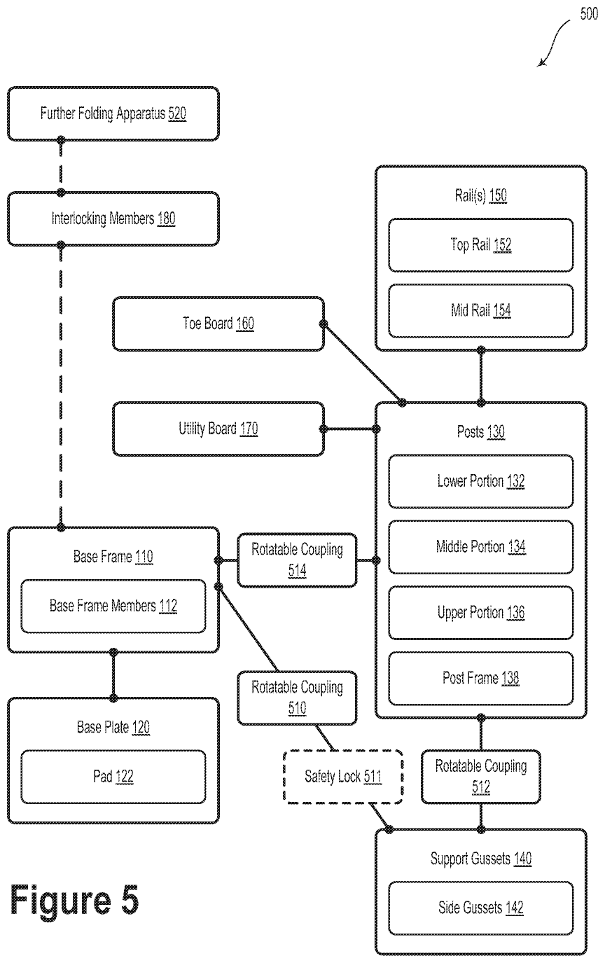

FIG. 5 illustrates a foldable apparatus 500, according to an example implementation. The foldable apparatus 500 and a base frame 110. The foldable apparatus 500 includes a base plate 120 coupled to the base frame 110. The base plate 120 is configured to support weight of a user.

The foldable apparatus 500 includes a plurality of posts 130. The posts 130 are rotatably coupled (e.g., by way of rotatable couplings 514) to the base frame 110. Each post 130 includes a lower portion 132, a middle portion 134, and an upper portion 136. The plurality of posts 130 includes at least a first post 130a and a second post 130b.

The foldable apparatus 500 includes a plurality of support gussets 140. Each support gusset 140 is rotatably coupled (e.g., by way of a rotatable coupling 510) to the base frame 110 and a respective upper portion 136 of at least one post 130. In some embodiments, the support gussets 140 could be physically locked to the base frame 110. For example, the foldable apparatus 500 could include a safety lock 511, which may be a latch, a bar, a switch, or another type of device configured to prevent the foldable apparatus 500 from folding and/or unfolding.

As described herein, elements that are “rotatably coupled” to one another could be coupled by way of a pin, a rotary bearing, or a rotary bushing and a stripper bolt. Other types of flexible and/or adjustable couplings are contemplated to join the relevant elements in a rotatable fashion. For example, it will be understood that other types of rotatable couplings are contemplated herein. Without limitation, elements of folding apparatus 500 could be rotatably coupled to one another by way of a straight or articulated axle, a clevis pin, a plain bearing (e.g., sleeve bearing/bushing), a ball bearing, or roller bearing, among other possibilities.

The foldable apparatus 500 includes a rail 150 coupled between respective upper portions 136 of at least the first post 130a and the second post 130b. The foldable apparatus 500 resists tipping based in part on the weight of the user. The support gussets 140 are configured to rotatably fold so as to adjust the plurality of posts 130 and the base frame 110 between a deployed configuration and a folded configuration.

In such scenarios, the deployed configuration includes the plurality of posts 130 being substantially perpendicular to a plane defined by the base frame 110. As such, the deployed configuration could provide a platform (e.g., base plate 120) for a user to stand on. The deployed configuration could also provide a physical barrier (e.g., rails 150 and support gussets 140) from falling or over-reaching while performing maintenance and/or repair operations.

Furthermore, the folded configuration includes the plurality of posts 130 being arranged at an acute angle (e.g., less than 45 degrees or less than 5 degrees) with respect to the plane defined by the base frame 110. In some embodiments, the folded configuration may include the plurality of posts 130 being completely folded along substantially the same plane as the base frame 110 and the support gussets 140.

In some embodiments, the foldable apparatus 500 includes a mid rail 154 coupled between respective middle portions 134 of at least the first post 130a and the second post 130b.

In various embodiments, the foldable apparatus 500 could include a toe board 160. The toe board 160 includes a flat material arranged along a plane between the first post 130a and the second post 130b. The flat material could additionally or alternatively be arranged between the mid rail 154 and base frame 110.

In example embodiments, the foldable apparatus 500 could additionally or alternatively include a pad 122. The pad 122 is coupled to the base plate 120. The pad 122 includes a cushioning material. In some embodiments, the cushioning material could include foam and/or rubber.

In some embodiments, the plurality of support gussets 140 could include at least two side gussets 142. In such scenarios, the at least two side gussets 142 are arranged proximate to opposing sides of the base frame 110. In some embodiments, the side gussets 142 could be configured to prevent the user from stepping off the sides of the foldable apparatus 500.

In some embodiments, the foldable apparatus 500 could include a lightweight material such as at least one of: molded plastic, polyvinylchloride (PVC) pipe, aluminum round or square tube, carbon fiber, steel, wood, bamboo, or wicker. It will be understood that other lightweight materials are possible and contemplated.

In some examples, the foldable apparatus 500 may weigh less than ten pounds.

It will be understood that the foldable apparatus 500 could be configured to fold in various ways. For example, the posts 130 could be configured to slide along the base plate 120 so as to fold substantially flat. Additionally or alternatively, the support gussets 140 could be configured to collapsibly fold so as to adjust the foldable apparatus 500 into a substantially flat configuration. In such a scenario, the support gussets 140 could be configured to collapse approximately in half and the posts 130 and base plate 120 could “scissor” closed.

Additionally or alternatively, the foldable apparatus 500 may include interlocking members 180 coupled to the base frame 110. The interlocking members 180 are configured to interlock with a further base frame of a further foldable apparatus 520 such that the foldable apparatus 500 and the further foldable apparatus 520 are configured to be fixedly coupled to each another.

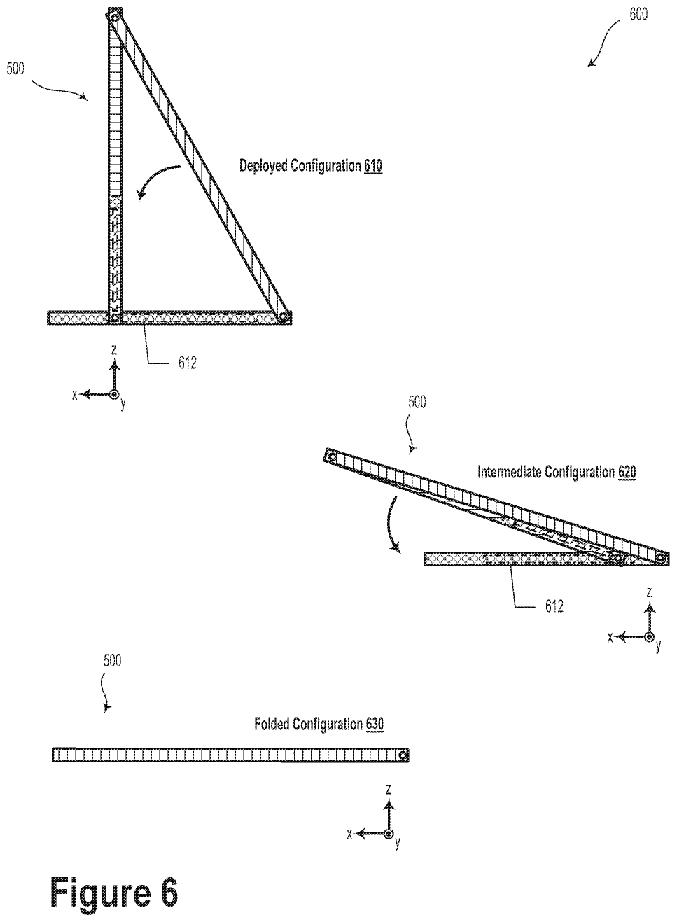

FIG. 6 illustrates various configurations of a foldable apparatus 500, according to example implementations. As an example, the foldable apparatus 500 could be configured to be utilized in a deployed configuration 610. In the deployed configuration 610, a user could stand on the base plate 120. Furthermore, the user could perform service and/or maintenance operations while standing on the base plate 120.

Additionally or alternatively, the foldable apparatus 500 could be configured to fold so as to provide an intermediate configuration 620. Furthermore, the foldable apparatus 500 could be configured to fold substantially completely “flat” into a folded configuration 630. The folded configuration 630 may be enable a convenient way to carry and/or move the foldable apparatus 500. It will be understood that other configurations are possible and contemplated.

In an example embodiment, the foldable apparatus 500 could include a sliding track 612, which may enable the posts of the foldable apparatus 500 to slide toward the ends of the support gussets and fold into the folded configuration 630.

As an example, while “pulsing” the aircraft assembly line, a user could manually move the foldable apparatus 500 to a useful position along a movable deck platform. In some embodiments, the user could move the foldable apparatus 500 while in the folded configuration 630 and then unfold the foldable apparatus 500 into the deployed configuration 610. In other embodiments, the user could move the foldable apparatus 500 while it is in the deployed configuration 610. Once positioned, the user could stand on the base plate 120 so as to weigh down the foldable apparatus 500 and perform various operations.

While certain application examples have been described for apparatus 100 and folding apparatus 500, it will be evident that other applications are possible and contemplated. That is, the apparatus 100 and/or folding apparatus 500 could be adaptable to various needs.

In an example embodiment, the apparatus 100 and/or folding apparatus 500 could be utilized by a ticket collector stand or booth. For example, the apparatus 100 and/or folding apparatus 500 could include a ticket window or opening configured to provide a space for a user to interact with a customer.

In other embodiments, the apparatus 100 and/or folding apparatus 500 could include a shelf. The shelf could be disposed at a height of about 36 inches or at another height. In other embodiments, the apparatus 100 and/or folding apparatus 500 could include another type of support to hold tools, supplies, materials, etc.

In various embodiments, the apparatus 100 and/or folding apparatus 500 could provide physical protection for individuals or objects. For example, the apparatus 100 and/or folding apparatus 500 could be formed, at least in part, by acrylic (e.g., plexiglass), polycarbonate or another type of hard, clear material. In such scenarios, a vehicle (e.g., an automobile) could be placed on the base plate and the post frame could be filled and/or covered by the hard, clear material. In such a way, the apparatus 100 and/or folding apparatus 500 could provide physical protection for various objects on one side of the apparatus 100 and/or folding apparatus 500 while being able to view them from the other side.

In yet further embodiments, a base frame of the apparatus 100 and/or folding apparatus 500 could be modified into a U-shape so that it may fit in front of a toilet and/or a urinal. For example, the apparatus 100 and/or folding apparatus 500 could be manually positioned near a toilet or urinal so as to provide a stable physical support for a user while utilizing toilet or urinal facilities. In such a scenario, the apparatus 100 and/or folding apparatus 500 could include one or more hand rails along the sides of the apparatus 100 and/or folding apparatus 500.

What is claimed is:

1. An apparatus comprising:
a base frame;
a base plate coupled to the base frame, wherein the base plate is configured to support weight of a user;
a plurality of posts coupled to the base frame, each post comprising a lower portion, a middle portion, and an upper portion, wherein the plurality of posts comprises at least a first post and a second post;
a plurality of support gussets, wherein each support gusset is coupled to the base frame and a respective upper portion of at least one post; and
a rail coupled between respective upper portions of at least the first post and the second post, wherein the apparatus resists tipping based in part on a weight of the user.

2. The apparatus of claim 1, further comprising:
a mid rail coupled between respective middle portions of at least the first post and the second post.

3. The apparatus of claim 2, further comprising:
a toe board, wherein the toe board comprises a flat material arranged along a plane between the first post and the second post and between the mid rail and base frame.

4. The apparatus of claim 1, further comprising a pad, wherein the pad is coupled to the base plate, wherein the pad comprises a cushioning material.

5. The apparatus of claim 4, wherein the cushioning material comprises foam.

6. The apparatus of claim 1, wherein the plurality of support gussets comprise at least two side gussets, wherein the at least two side gussets are arranged proximate to opposing sides of the base frame, wherein the side gussets are configured to prevent the user from stepping off the sides of the apparatus.

7. The apparatus of claim 1, wherein the apparatus comprises a lightweight material.

8. The apparatus of claim 7, wherein the lightweight material comprises at least one of: molded plastic, polyvinylchloride pipe, aluminum round or square tube, carbon fiber, steel, wood, bamboo, or wicker.

9. The apparatus of claim 1, wherein the apparatus weighs less than ten pounds.

10. The apparatus of claim 1, further comprising interlocking members coupled to the base frame, wherein the interlocking members are configured to interlock with a further base frame of a further apparatus such that the apparatus and the further apparatus are configured to be fixedly coupled to each another.

11. The apparatus of claim 1, further comprising:
a post frame, wherein the post frame comprises at least two of the posts and the rail; and
a utility board coupled to the post frame, wherein the utility board comprises at least one tool storage pocket.

12. An foldable apparatus comprising:
a base frame;
a base plate coupled to the base frame, wherein the base plate is configured to support weight of a user;
a plurality of posts rotatably coupled to the base frame, each post comprising a lower portion, a middle portion, and an upper portion, wherein the plurality of posts comprises at least a first post and a second post;
a plurality of support gussets, wherein each support gusset is rotatably coupled to the base frame and a respective upper portion of at least one post; and
a rail coupled between respective upper portions of at least the first post and the second post, wherein the foldable apparatus resists tipping based in part on a weight of the user, wherein the support gussets are configured to rotatably fold so as to adjust the plurality of posts and the base frame between a deployed configuration and a folded configuration.

13. The foldable apparatus of claim 12, wherein the deployed configuration comprises the plurality of posts being substantially perpendicular to a plane defined by the base frame, and wherein the folded configuration comprises the plurality of posts being arranged at an acute angle with respect to the plane defined by the base frame.

14. The foldable apparatus of claim 12, further comprising:
a mid rail coupled between respective middle portions of at least the first post and the second post; and
a toe board, wherein the toe board comprises a flat material arranged along a plane between the first post and the second post and between the mid rail and base.

15. The foldable apparatus of claim 12, further comprising a pad, wherein the pad is coupled to the base plate, wherein the pad comprises a cushioning material, wherein the cushioning material comprises foam.

16. The foldable apparatus of claim 12, wherein the plurality of support gussets comprise at least two side gussets, wherein the at least two side gussets are arranged proximate to opposing sides of the base frame, wherein the side gussets are configured to prevent the user from stepping off the sides of the foldable apparatus.

17. The foldable apparatus of claim 12, wherein the foldable apparatus comprises a lightweight material.

18. The foldable apparatus of claim 17, wherein the lightweight material comprises at least one of: molded plastic, polyvinylchloride pipe, aluminum round or square tube, carbon fiber, steel, wood, bamboo, or wicker.

19. The foldable apparatus of claim 12, wherein the foldable apparatus weighs less than ten pounds.

20. The foldable apparatus of claim 12, further comprising interlocking members coupled to the base frame, wherein the interlocking members are configured to interlock with a further base frame of a further foldable apparatus such that the foldable apparatus and the further foldable apparatus are configured to be fixedly coupled to each another.
